(19) United States
(12) Patent Application Publication
(10) Pub. No.: US 2013/0187808 A1
(43) Pub. Date: Jul. 25, 2013

(54) RADAR APPARATUS AND ANTENNA APPARATUS

(71) Applicant: MANDO CORPORATION, Gyeonggi-do (KR)

(72) Inventors: Su Han Kim, Gyeonggi-do (KR); Sung Joon HEO, Seoul (KR); Hyung Suk HAM, Gyeonggi-do (KR); Jong Gyu PARK, Gyeonggi-do (KR)

(73) Assignee: MANDO CORPORATION, Gyeonggi-do (KR)

(21) Appl. No.: 13/747,024

(22) Filed: Jan. 22, 2013

(30) Foreign Application Priority Data
Jan. 19, 2012 (KR) 10-2012-0006362

(51) Int. Cl. G01S 7/03

(52) U.S. Cl. CPC G01S 7/032
USPC 342/175

(57) ABSTRACT

The present invention relates to radar and antenna technologies. More particularly, the present invention relates to an antenna apparatus and radar apparatus that have an antenna structure that enables a high antenna gain and a balanced beam pattern by preventing a distortion of a beam pattern caused by a coupling phenomenon between antenna arrays.

### CROSS-REFERENCE TO RELATED APPLICATION

This application claims priority from and the benefit under 35 U.S.C. §119(a) of Korean Patent Application No. 10-2012-0006362, filed on Jan. 19, 2012, which is hereby incorporated by reference for all purposes as if fully set forth herein.

### BACKGROUND OF THE INVENTION

1. Field of the Invention

The present invention relates to radar and antenna technologies.

2. Description of the Prior Art

A conventional radar apparatus is provided with a plurality of array antennas to be used as a transmission antenna or a reception antenna, in which case a signal coupling phenomenon may occur between the array antennas.

Such a coupling phenomenon between array antennas may produce a distortion phenomenon that a beam pattern is distorted in one direction. As a result, the distortion phenomenon causes problems of reducing an antenna gain and unbalancing a beam pattern. Consequently, the coupling phenomenon is a major factor that may greatly deteriorate the sensing performance of a radar apparatus.

### SUMMARY OF THE INVENTION

Accordingly, the present invention has been made to solve the above-mentioned problems occurring in the prior art, and an object of the present invention is to provide an antenna apparatus and a radar apparatus that have a antenna structure that enables a high antenna gain and a balanced beam pattern by preventing a distortion of a beam pattern caused by a coupling phenomenon between antenna arrays.

In order to accomplish this object, there is provided a radar apparatus including: a long-distance transmission antenna unit including a plurality of long-distance transmission array antennas; a short-distance transmission antenna unit including one or more short-distance transmission array antennas; a reception antenna unit including a plurality of reception array antennas; a signal transmission/reception unit configured to transmit a signal through the long-distance transmission antenna unit and/or the short-distance transmission antenna unit, and to receive the transmitted signal through the reception antenna unit when the transmitted signal is reflected from the surroundings; and a dummy array antenna arranged in each of the opposite sides of the plurality of long-distance transmission array antennas, each of the opposite sides of the one or more short-distance transmission array antennas, and/or each of the opposite sides of the plurality of reception array antennas. The dummy array antenna is not connected with the signal transmission/reception unit.

The long-distance transmission antenna unit, the short-distance transmission antenna unit, the reception antenna unit, and the signal transmission/reception unit may be mounted on one side of a printed circuit board.

The length of a first region where the long-distance transmission antenna unit is mounted may be longer than a second region where the short-distance transmission antenna unit is mounted, a third region where the reception antenna unit is mounted, and a fourth region where the signal transmission/reception unit is mounted.

The radar apparatus may further include a protective member configured to cover the signal transmission/reception unit mounted on the printed circuit board to protect the signal transmission/reception unit. The protective member may be coupled to the one side of the printed circuit board.

The protective member may have a size that covers only the fourth region where the signal transmission/reception unit is mounted on the printed circuit board.

According to another aspect of the present invention, there is provided an antenna apparatus including: a plurality of array antennas; and a fake array antenna arranged in each side of the plurality of array antennas. The fake array antenna is not connected with a signal transmission/reception unit in order to prevent beam pattern distortion by a signal coupling between neighboring array antennas among the plurality of array antennas.

In accordance with another aspect of the present invention, there is provided an antenna apparatus and radar apparatus that have an antenna structure that enables a high antenna gain and a balanced beam pattern by preventing a distortion of a beam pattern caused by a coupling phenomenon between antenna arrays.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram for a radar apparatus according to an exemplary embodiment of the present invention;

FIG. 2 illustrates one side of a printed circuit board on which a long-distance transmission antenna unit, a short-distance transmission antenna unit, and a signal transmission/reception unit included in the radar apparatus of the exemplary embodiment of FIG. 1;

FIG. 3 exemplifies that dummy array antennas are arranged in the reception antenna mounted on the one side of the printed circuit board;

FIG. 4 exemplifies that dummy array antennas are arranged in the long-distance transmission antenna mounted on the one side of the printed circuit board;

FIG. 5 exemplifies that dummy array antennas are arranged in each of the long-distance transmission antenna and the reception antenna mounted on the one side of the printed circuit board;

FIG. 6 exemplifies an antenna structure in which at least one long-distance transmission array antennas have a different distance among a plurality of long-distance transmission array antennas included in the long-distance transmission antenna unit mounted on the one side of the printed circuit board;

FIG. 7 comparatively illustrates beam pattern balances for a case where dummy array antennas are arranged in the reception antenna unit mounted on the one side of the printed circuit board, and a case where no dummy array antenna is arranged; and

FIG. 8 illustrates an antenna apparatus according to another exemplary embodiment of the present invention.

### DETAILED DESCRIPTION OF THE PREFERRED EMBODIMENTS

Hereinafter, exemplary embodiments of the present invention will be described with reference to the accompanying drawings. In the following description, it shall be noted that the same elements will be designated by the same reference numerals if possible even though they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

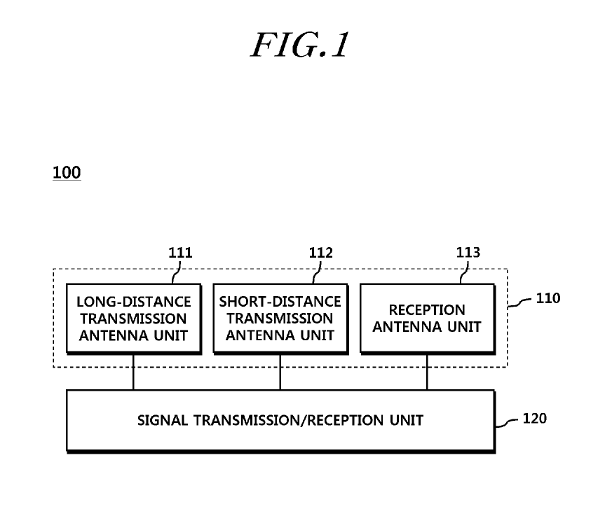

FIG. 1 is a block diagram for a radar apparatus according to an exemplary embodiment of the present invention.

Referring to FIG. 1, the radar apparatus 100 according to the exemplary embodiment of the present invention includes: an antenna apparatus 110 configured to transmit a signal for sensing surroundings, and to receive the transmitted signal when the transmitted signal is reflected from the surroundings; and a signal transmission/reception unit 120 configured to perform signal transmission/reception through the antenna apparatus 110.

Referring to FIG. 1, the antenna apparatus 110 includes: a long-distance transmission antennas 111 including a plurality of long-distance transmission array antennas; a short-distance transmission antenna 112 including one or more short-distance transmission array antennas; and a reception antenna 113 including a plurality of reception array antennas.

The antenna apparatus 110 may further include a power divider configured to regulate or divide a power supplied to each of the plurality array antennas.

The signal transmission/reception unit 120 may transmit a signal through the long-distance transmission antenna unit 111 and/or the short-distance transmission antenna unit 112, and receive the transmitted signal through the reception antenna unit 113 when the transmitted antenna is reflected from the surroundings.

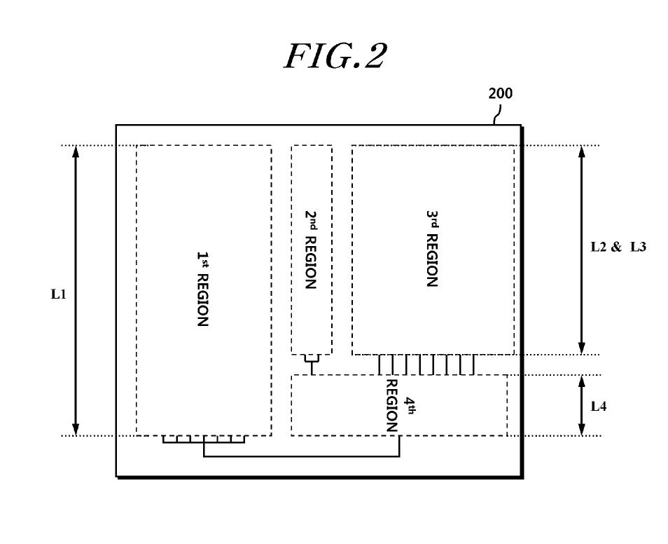

With reference to FIG. 2, descriptions will be made as to how to implement the antenna apparatus 110 and the signal transmission/reception unit 120 included in the radar apparatus 100 according to the present embodiment, in which the antenna apparatus 110 includes a long-distance transmission antenna unit 111, a short-distance transmission antenna unit 112, and a reception antenna unit 113.

FIG. 2 illustrates one side of a printed circuit board on which the long-distance transmission antenna unit 111, the short-distance transmission antenna unit 112, the reception antenna unit 113, and the signal transmission/reception unit 120, which are included in the radar apparatus 100 according to the exemplary embodiment of the present embodiment, are mounted.

Referring to FIG. 2, in implementing the radar apparatus 100 according to the present exemplary embodiment, the antenna apparatus 110 including the long-distance transmission antenna unit 111, the short-distance transmission antenna unit 112, the reception antenna unit 113, and the signal transmission/reception unit 120 may be mounted on one side of a single printed circuit board (PCB) 200 in unison.

For this purpose, the one side of the printed circuit board 200 may be divided into a first region where long-distance transmission antenna unit 111 is mounted, a second region where the short-distance transmission antenna unit 112 is mounted, a third region where reception antenna unit 113 is mounted, and a fourth region where the signal transmission/reception unit 120. Each structure is mounted in one corresponding region.

Meanwhile, in connection with the structure in which the antenna apparatus 110 including the long-distance transmission antenna unit 111, the short-distance transmission antenna unit 112, the reception antenna unit 113, and the signal transmission/reception unit 120 of the radar apparatus 100 are mounted on the single printed circuit board 200, in the prior art, a separate printed circuit board was required on which a plurality of circuit devices are mounted for a signal transmission function. However, in the present exemplary embodiment, since the signal transmission/reception unit 120 may be implemented as a single chip, the signal transmission/reception unit 120 be may mounted on the single printed circuit board together with the antenna apparatus 110.

For this reason, the radar apparatus 100 according to the present exemplary embodiment has advantageous effects in that the radar apparatus can be miniaturized in size and the degree of freedom for a place for mounting the radar apparatus 100 in a vehicle or the like can be enhanced.

Meanwhile, in the radar apparatus 100 according to the present exemplary embodiment, in order to enable a long-distance sensing by the long-distance transmission antenna unit 111, and to mount the long-distance transmission antenna unit 111, the short-distance transmission antenna unit 112, the reception antenna unit 113, and the signal transmission/reception unit 120 on one single PCB 200, the sizes, positions, and arrangements of the first region, second region and third region that form one side of the PCB 200 may adopt the optimized configuration as illustrated in FIG. 2.

For example, the length L1 of the first region where the long-distance transmission antenna unit 111 is mounted is longer than the length L2 of the second region where the short-distance transmission antenna unit 112, the length L3 of the third region where reception antenna unit 113 is mounted, and the length L4 of the fourth region where the signal transmission/reception unit 120 is mounted. That is, L1>L2, L1>L3, and L1>L4.

Meanwhile, because the signal transmission/reception unit 120 mounted on the printed circuit board 200 is wire-bonded to the printed circuit board 200, the signal transmission/reception unit 120 may protrude from the printed circuit board 200. Thus, it is required to protect the signal transmission/reception unit 120.

Accordingly, in order to protect the signal transmission/reception unit 120 mounted on the printed circuit board 200, a protective member configured to cover the signal transmission/reception unit may be coupled to the top side of the printed circuit board 200.

The protective member for protecting the signal transmission/reception unit 120 may have a size that covers only the forth region where the signal transmission/reception unit 120 on the printed circuit board 200 such that the protective member does not disturb a signal transmission through the long-distance transmission antenna unit 111 or the short-distance transmission antenna unit 112, and a signal reception through the reception antenna unit 113 while being coupled to the top side of the printed circuit board 200.

In addition, the protective member for protecting the signal transmission/reception unit 120 may be formed with a groove that serves as a passage for a wire for connecting the signal transmission/reception unit 120 to each of the long-distance transmission antenna unit 111, the short-distance transmission antenna unit 112, and the reception antenna unit 113.

Meanwhile, all the plurality of long-distance transmission array antennas included in the long-distance transmission antenna unit 111 may have the same antenna length, or at least one of the long-distance transmission array antennas may have a different antenna length.

If at least one of the plurality of long-distance transmission array antennas has a different antenna length, the plurality of long-distance transmission array antennas may have a configuration in which among the plurality of long-distance transmission array antennas, the long-distance transmission array antenna arranged at the center of the plurality of long-distance transmission array antennas may have the longest antenna length and the antenna lengths of the other long-distance transmission array antennas may be reduced as approaching to the opposite sides.

Meanwhile, the radar apparatus 100 may further include a switch for selecting one of the long-distance transmission antenna unit 111 and the short-distance transmission antenna unit 112 as an antenna unit for signal transmission in order to selectively conduct a long-distance sensing and a short-distance sensing.

The sensing distance is proportional to the number of the transmission array antennas, and the sensing angle is inversely proportional to the number of the array antennas.

In connection with this, the number of the plurality of long-distance transmission array antennas may be determined to be proportional to a long-distance sensing distance predetermined as a designing value, and the number of one or more short-distance transmission array antennas may be determined to be proportional to a short-distance sensing distance predetermined as a designing value. That is, because the long-distance sensing distance is longer than the short-distance sensing distance, the number of the plurality of the long-distance transmission array antennas is determined to be larger than the number of the one or more short-distance transmission array antennas.

In addition, the number of the plurality of long-distance transmission array antennas may be determined to be inversely proportional to the long-distance sensing angle preset as a designing value, and the number of the one or more short-distance transmission array antennas may be determined to be inversely proportional to the short-distance sensing angle preset as a designing value. That is, if the long-distance sensing angle is narrower than the short-distance sensing angle, the number of the plurality of long-distance transmission array antennas may be determined to be larger than the number of the one or more short-distance transmission array antennas.

Meanwhile, the antenna apparatus 110 may further include a dummy array antenna which is arranged in each of the opposite sides of the plurality of long-distance transmission array antennas, each of the opposite sides of the one or more short-distance transmission array antennas, and/or each of the opposite sides of the plurality of reception array antennas. The dummy array antenna is not connected with the signal transmission/reception unit 120.

Here, the description, “the dummy array antenna is not connected with the signal transmission/reception unit 120,” means that the dummy array antenna is disconnected in circuit, and no power is supplied to the dummy array antenna.

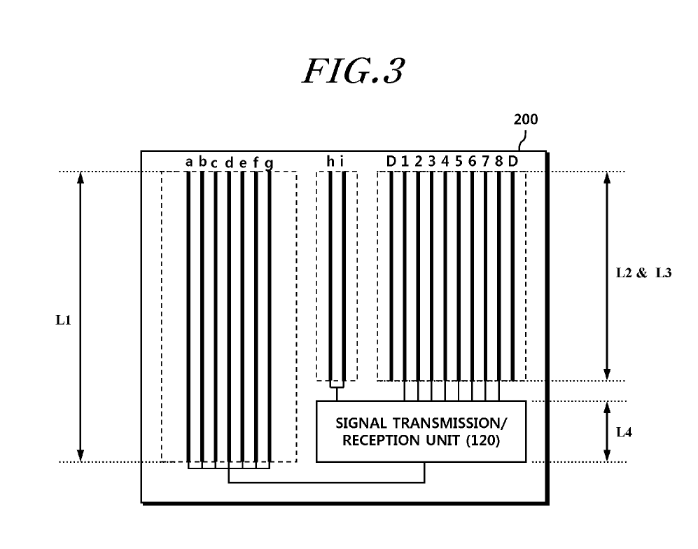

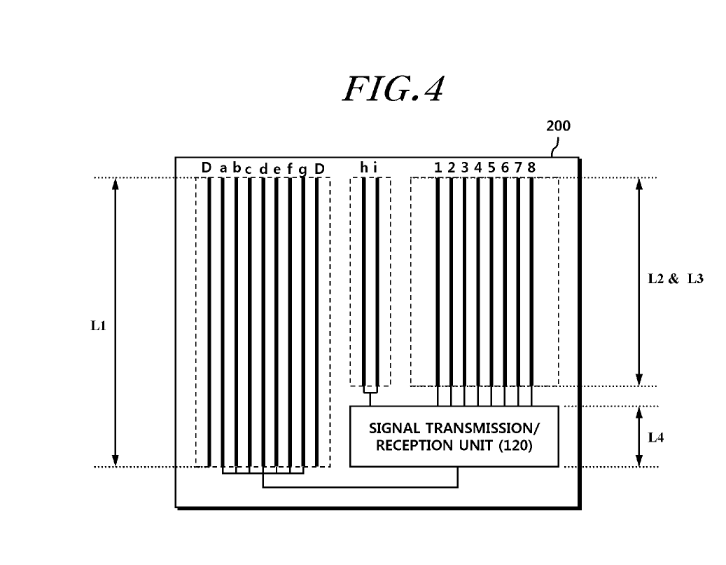

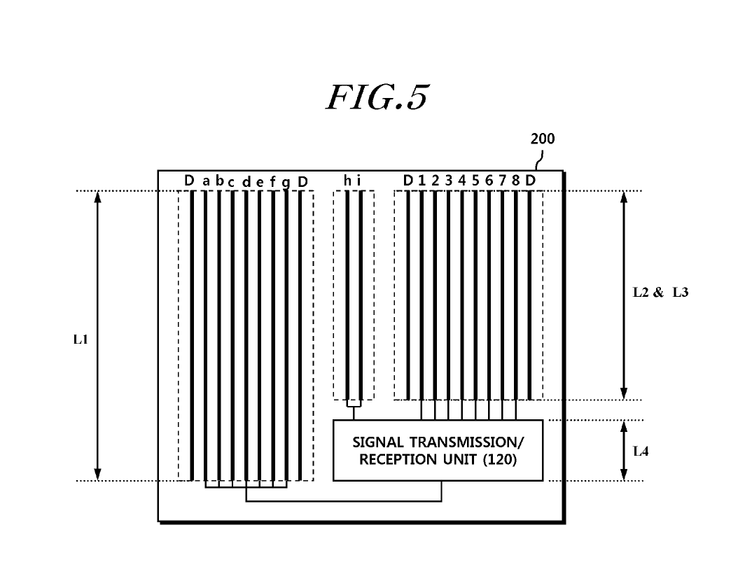

In other words, the dummy array antenna, which is not connected with the signal transmission/reception unit 120 in circuit, may be arranged in each side of the plurality of long-distance transmission array antennas (see FIG. 4). The dummy array antenna which is not connected with the signal transmission/reception unit 120 in circuit, may be arranged in each side of the one or more short-distance transmission array antennas, or the dummy array antenna which is not connected with the signal transmission/reception unit 120 in circuit, may be arranged in each side of the plurality of reception array antennas (see FIG. 3). In addition, the dummy array antenna which is not connected with the signal transmission/reception unit 120 in circuit, may be arranged in two or more, or all of the opposite sides of the plurality of long-distance transmission array antennas, the opposite side of the one or more short-distance transmission array antennas and the opposite sides of the plurality of reception array antennas (see FIG. 5).

The reason for additionally arranging dummy array antennas is to reduce the distortion of beam patterns caused by a signal coupling, thereby balancing the beam patterns in the opposite sides.

An antenna structure, in which the above-described dummy array antennas are additionally arranged, will be described with reference to FIGS. 3 to 5 by way of an example.

In the examples of FIGS. 3 to 5, the long-distance transmission antenna unit 111 includes seven long-distance transmission array antennas a, b, c, d, e, f, and g, the short-distance transmission antenna unit 112 includes two short-distance transmission array antennas h and i, and the reception antenna unit 113 includes eight reception array antennas 1, 2, 3, 4, 5, 6, 7, and 8.

FIG. 3 exemplifies that the dummy array antennas D are arranged in the reception antenna unit 113 mounted on the printed circuit board 200.

Assuming that no dummy array antenna D exists with reference to FIG. 3, each of the reception array antennas 2, 3, 4, 5, 6, and 7, except the reception array antennas 1 and 8, among the eight reception array antennas 1, 2, 3, 4, 5, 6, 7, and 8 is provided with reception array antennas in the opposite sides around itself. However, each of the reception array antenna 1 and the reception array antenna 8 is provided with a reception array antenna in only one side around itself. Therefore, a phenomenon, in which a beam pattern according to the signal reception in each of the reception array antenna 1 and the reception array antenna 8 is distorted in one direction to unbalance the beam pattern, may occur unlike in the other reception array antennas 2, 3, 4, 5, 6, and 7.

However, if the dummy array antennas D are arranged in the opposite sides of the eight reception array antenna 1, 2, 3, 4, 5, 6, 7, and 8, that is, if a dummy array antenna D is arranged in each of the left side of the reception array antenna 1 and the right side of the reception array antenna 8, each of the reception array antenna 1 and the reception array antenna 8 takes a configuration in which reception array antennas are arranged in the opposite sides around itself like the other reception array antennas 2, 3, 4, 5, 6, and 7. Therefore, the phenomenon, in which a beam pattern according to the signal reception in each of the reception array antenna 1 and the reception array antenna 8 is distorted in one direction to unbalance the beam pattern, does not occur.

FIG. 4 exemplifies that dummy array antennas D are arranged in the long-distance transmission antenna unit 111 mounted on the one side of the printed circuit board 200.

Assuming that no dummy array antenna D exists with reference to FIG. 4, each of five long-distance transmission array antennas b, c, d, e, and f except the long-distance transmission array antenna a and the long-distance transmission array antenna g among the seven long-distance transmission array antennas a, b, c, d, e, f, and g is provided with long-distance transmission array antennas in opposite sides around itself. However, each of the long-distance transmission array antenna a and the long-distance transmission array antenna g is provided with a long-distance transmission array antenna only in one side around itself. Therefore, a phenomenon, in which a beam pattern according to the long-distance signal transmission in each of the long-distance transmission array antenna a and the long-distance transmission array antenna g is distorted in one direction to unbalance the beam pattern, may occur unlike in the other long-distance transmission array antennas b, c, d, e, and f.

However, as illustrated in FIG. 4, if the dummy array antennas D are arranged in the opposite sides of the seven long-distance transmission array antennas a, b, c, d, e, f, and g, that is, if a dummy array antenna D is arranged in each of the left side of long-distance transmission array antenna a and the right side of long-distance transmission array antenna g, each of the long-distance transmission array antenna a and the long-distance transmission array antenna g takes a configuration in which long-distance transmission array antennas are arranged in the opposite sides around itself like the other long-distance transmission array antennas b, c, d, e, and f. Accordingly, the phenomenon, in which a beam pattern according to the long-distance signal transmission in each of the long-distance transmission array antenna a and the long-distance transmission array antenna g is distorted in one direction to unbalance the beam pattern, does not occur.

FIG. 5 illustrates that dummy array antennas D are arranged in the long-distance transmission antenna unit 111 and the reception antenna unit 113 mounted on the one side of the printed circuit board 200, respectively.

Referring to FIG. 5, the dummy array antennas D are arranged in the opposite sides of the eight reception array antennas 1, 2, 3, 4, 5, 6, 7, and 8, that is, a dummy array antenna D is arranged in each of the left side of the reception array antenna 1 and the right side of the reception array antenna 8. Therefore, each of the reception array antenna 1 and the reception array antenna 8 takes a configuration in which reception array antennas are arranged in the opposite sides around itself as the same with the other reception array antenna 2, 3, 4, 5, 6, and 7. Accordingly, the phenomenon, in which a beam pattern according to the signal reception in each of the reception array antenna 1 and reception array antenna 8 is distorted in one direction to unbalance the beam pattern, does not occur.

In addition, referring to FIG. 5, the dummy array antennas D are arranged in the opposite sides of the seven long-distance transmission array antennas a, b, c, d, e, f, and g, that is, the dummy array antenna D is arranged in each of the left side of long-distance transmission array antenna a and the right side of long-distance transmission array antenna g, respectively. Therefore, each of the long-distance transmission array antenna a and the long-distance transmission array antenna g takes a configuration in which long-distance transmission array antennas are arranged in the opposite sides around itself like the other long-distance transmission array antennas b, c, d, e, and f. Accordingly, a phenomenon, in which a beam pattern according to the long-distance signal transmission in each of the long-distance transmission array antenna a and the long-distance transmission array antenna g is distorted in one direction to unbalance the beam pattern, does not occur.

As described above, all the plurality of long-distance transmission array antennas included in the long-distance transmission antenna unit 111 may have the same antenna length, or at least one of the long-distance transmission array antennas may have a different antenna length. However, it is assumed that the antenna lengths in the first region are the same.

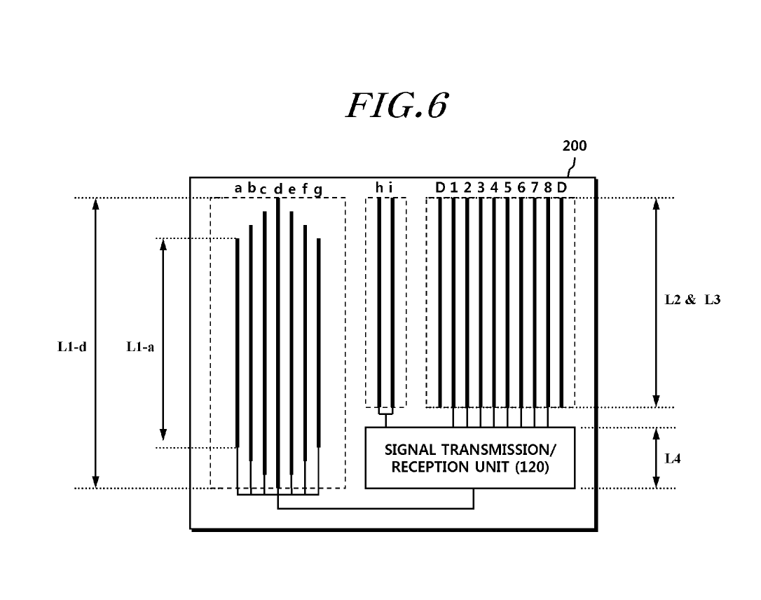

FIG. 6 exemplifies that one or more long-distance transmission array antennas among the long-distance transmission array antennas a, b, c, d, e, f, and g included in the long-distance transmission antenna unit 111 mounted on the one side of the printed circuit board 200.

As illustrated in FIG. 6, there may be provided an antenna configuration in which among the seven long-distance transmission array antennas a, b, c, d, e, f, and g, the long-distance transmission array antenna d arranged at the center has the longest antenna length L1-d, and the antenna lengths of the other long-distance transmission array antennas are reduced as approaching the opposites sides. That is, in FIG. 6, the antenna lengths of the seven long-distance transmission array antennas a, b, c, d, e, f, and g are as follows: L1_{d}>L1_{c}, L1_{c}=L1ₑ, L1ₑ>L1_{b}, L1_{b}=L1_{f}, L1_{f}>L1ₐ, and L1ₐ=L1_{g}.

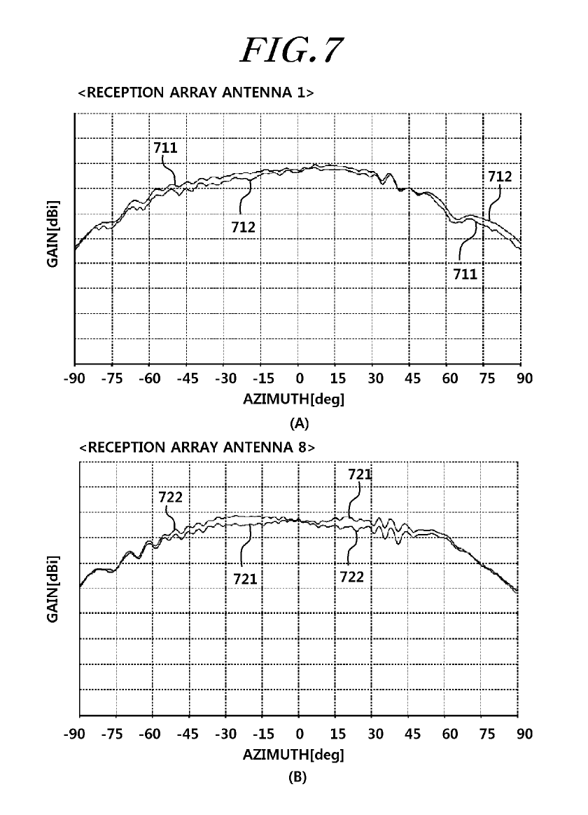

FIG. 7 comparatively illustrates the balances of beam patterns for a case where dummy array antennas D are arranged in the reception antenna unit 113 mounted on the one side of the printed circuit board, and a case where no dummy array antenna is arranged.

FIG. 7a illustrates a signal gain in relation to an azimuth according to the signal reception in the reception array antenna 1 by a graph for each of the case where a dummy array antenna D is arranged in the left side of the reception array antenna 1 included in the reception antenna unit 113 mounted on the one side of the printed circuit board, and the case where the dummy array antenna D is not arranged in the left side of the reception array antenna 1.

Referring to FIG. 7a, from the line 711 representing a gain in relation to an azimuth in the case where a dummy array antenna D is arranged in the left side of the reception array antenna 1, it can be seen that because the dummy antenna D and the reception array antenna 2 are provided in the opposite sides around the reception array antenna 1, the gain values in the plus (+) direction and the gain values in the minus (−) direction are balanced with each other with reference to the gain value at the zero (0) degree azimuth.

However, from the line 712 representing a gain in relation to an azimuth for the case where the dummy array antenna D is not arranged in the left side of the reception array antenna 1, it can be seen that because the reception array antenna 2 is provided in only one side (right side) around the reception array antenna 1, the gain values in the plus (+) direction and the gain values in the minus (−) direction are less balanced with each other with reference to the gain value at the zero (0) degree azimuth.

FIG. 7b illustrates a signal gain in relation to an azimuth according to the signal reception in the reception array antenna 8 by a graph for each of the case where a dummy array antenna D is arranged in the right side of the reception array antenna 8 included in the reception antenna unit 113 mounted on the one side of the printed circuit board, and the case where the dummy array antenna D is not arranged in the left side of the reception array antenna 1.

Referring to FIG. 7b, from the line 721 representing a gain in relation to an azimuth for the case where a dummy array antenna D is arranged in the right side of the reception array antenna 8, it can be seen that because the reception array antenna 7 and the dummy antenna D are provided in the opposite sides around the reception array antenna 8, the gain values in the plus (+) direction and the gain values in the minus (−) are balanced with each other with reference to the gain value at the zero (0) degree azimuth.

However, from the line 722 representing a gain in relation to an azimuth for the case where the dummy array antenna D is not arranged in the right side of the reception array antenna 8, it can be seen that because the reception array antenna 7 is provided in only one side (left side) around the reception array antenna 8, the gain values in the plus (+) direction and the gain values in the minus (−) direction are less balanced with each other with reference to the gain value at the zero (0) degree azimuth.

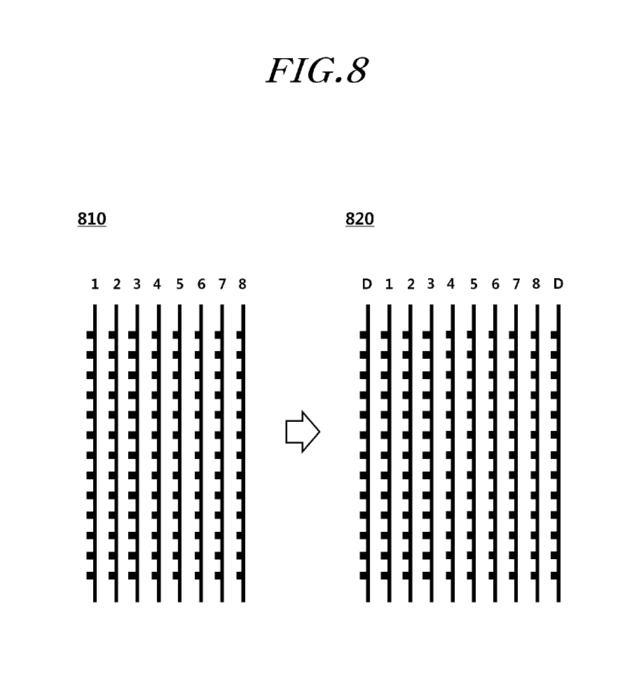

FIG. 8 illustrates an antenna apparatus 820 according to another exemplary embodiment of the present invention.

Referring to FIG. 8, the antenna apparatus 820 according to another exemplary embodiment of the present invention may include fake array antennas D which are arranged in the opposite sides of a plurality of array antennas 1, 2, 3, 4, 5, 6, 7, and 8, and not connected with the signal transmission/reception unit in order to prevent beam pattern distortion caused by a signal coupling between the plurality of array antennas 1, 2, 3, 4, 5, 6, 7, and 8, and an array antenna adjoining the plurality of array antennas 1, 2, 3, 4, 5, 6, 7, and 8. Here, the fake array antennas may be referred as dummy array antennas.

The antenna apparatus 820 may further include a power divider for regulating or dividing the power supplied to various array antennas to be equal to or different from each other.

In order to reduce an SLL (Side Lobe Level), the power divider may supply the highest power to the array antennas 4 and 5 arranged at the center among the plurality of array antennas 1, 2, 3, 4, 5, 6, 7, and 8, and supply power to the other array antennas in such a manner that the power is reduced as approaching to the opposite sides from the array antennas 4 and 5 to the opposite sides.

Referring to the antenna apparatus 810 which is not provided with a fake array antenna D in FIG. 8, each of the array antennas 2, 3, 4, 5, 6, and 7 except the array antenna 1 and the array antenna 8 is provided with array antennas in the opposite sides thereof. Accordingly, each of the array antennas 2, 3, 4, 5, 6 and 7 is balanced in beam pattern because a coupling phenomenon occurs for each of the array antenna arranged in the left side thereof and the array antennas arranged in the right side.

However, in the antenna apparatus 810 which is not provided with the fake array antenna D, the beam pattern by the array antenna 1 is not balanced because the array antenna 2 is arranged adjacent only to the right side of the array antenna 1 and a coupling phenomenon by the array antenna 2 arranged in the right side of the array antenna 1 occurs.

Like this, the beam pattern by the array antenna 8 is not balanced because the array antenna 7 is arranged adjacent only to the left side of the array antenna 8 and a coupling phenomenon by the array antenna 7 arranged in the left side of the array antenna 8 occurs.

However, referring to the antenna apparatus 820 which is provided with the fake array antennas D in FIG. 8, each of the plurality of array antennas 1, 2, 3, 4, 5, 6, 7, and 8 is provided with array antennas in both of left and right sides. Therefore, each of the array antennas 1, 2, 3, 4, 5, 6, 7, and 8 is balanced in beam pattern because the coupling phenomenon occurs at each of the array antenna arranged in the left side and the array antenna arranged in right side such that the beam pattern is balanced.

For the array antenna 1, the fake array antenna D is arranged adjacent to the left side and the array antenna 2 is arranged adjacent to the right side. Therefore, the coupling phenomenon by the fake array antenna D arranged in the left side and the coupling phenomenon by the array antenna 2 arranged in the right side occur simultaneously such that the beam pattern is balanced.

Like this, for the array antenna 8, the fake array antenna D is arranged adjacent to the right side and the array antenna 7 is arranged adjacent to the left side. Therefore, the coupling phenomenon by the array antenna 7 arranged in the left side and the coupling phenomenon by the fake array antenna D arranged in the right side occur simultaneously such that the beam pattern is balanced.

In FIG. 8, each of the plurality array antennas 1, 2, 3, 4, 5, 6, 7, and 8 may be a transmission antenna or a reception antenna.

As described above, according to the present invention, an antenna apparatus 110 or 820 and a radar apparatus 100 having a high antenna gain and enabling a balanced beam pattern can be provided by preventing a beam pattern distortion by a coupling phenomenon between array antennas.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the exemplary embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A radar apparatus comprising:
a long-distance transmission antenna unit comprising a plurality of long-distance transmission array antennas;
a short-distance transmission antenna unit comprising one or more short-distance transmission array antennas;
a reception antenna unit comprising a plurality of reception array antennas;
a signal transmission/reception unit configured to transmit a signal through the long-distance transmission antenna unit and/or the short-distance transmission antenna unit, and to receive the transmitted signal through the reception antenna unit when the transmitted signal is reflected from the surroundings; and
a dummy array antenna arranged in each of the opposite sides of the plurality of long-distance transmission array antennas, each of the opposite sides of the one or more short-distance transmission array antennas, and/or each of the opposite sides of the plurality of reception array antennas, wherein the dummy array antenna is not connected with the signal transmission/reception unit.

2. The radar apparatus of claim 1, wherein the long-distance transmission antenna unit, the short-distance transmission antenna unit, the reception antenna unit, and the signal transmission/reception unit are mounted on one side of a printed circuit board.

3. The radar apparatus of claim 2, wherein the length of a first region where the long-distance transmission antenna unit is mounted is longer than a second region where the short-distance transmission antenna unit is mounted, a third region where the reception antenna unit is mounted, and a fourth region where the signal transmission/reception unit is mounted.

4. The radar apparatus of claim 3, further comprising a protective member configured to cover the signal transmission/reception unit mounted on the printed circuit board to protect the signal transmission/reception unit, wherein the protective member is coupled to the one side of the printed circuit board.

5. The radar apparatus of claim 4, wherein the protective member has a size that covers only the fourth region where the signal transmission/reception unit is mounted on the printed circuit board.

6. An antenna apparatus comprising:
a plurality of array antennas; and
a fake array antenna arranged in each side of the plurality of the plurality of array antennas without being connected with a signal transmission/reception unit in order to prevent beam pattern distortion by a signal coupling between neighboring array antennas among the plurality of array antennas.
